(19) United States
(12) Patent Application Publication
(10) Pub. No.: US 2005/0201008 A1
(43) Pub. Date: Sep. 15, 2005

(54) Deck chassis assembly for a magnetic recording/reproducing apparatus

(75) Inventor: Chang-Hee Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/052,858

(22) Filed: Feb. 9, 2005

(30) Foreign Application Priority Data
Mar. 10, 2004 (KR) 2004-16028

(51) Int. Cl. G11B 15/00

(52) U.S. Cl. 360/96.5

(57) ABSTRACT

A deck chassis assembly for a magnetic recording/reproducing apparatus, in which some parts may be sub-assembled for independent operation, comprises a base chassis mounting a moving deck therein. The base chassis includes integrally formed sidewalls at opposite sides thereof to mount and receive the moving deck. A housing chassis has sidewalls of which opposite ends are rotatably connected to ends of the sidewalls of the base chassis, and a link member is interposed between the housing chassis and the base chassis to enable the housing chassis to rotate a predetermined angle relative to the base chassis in an opening and closing manner.

### CROSS-REFERENCE TO RELATED APPLICATIONS

This application claims the benefit under 35 U.S.C. § 119(a), of Korean Patent Application No. 2004-16028, entitled “Deck Chassis Structure for Magnetic Recording/Reading Apparatus,” filed Mar. 10, 2004, the entire disclosure of which is hereby incorporated by reference.

### BACKGROUND OF THE INVENTION

1. Field of the Invention

The present invention relates to a deck mechanism for a magnetic recording/reproducing apparatus. More particularly, aspects of the present invention relate to a deck chassis assembly for a magnetic recording/reproducing apparatus in which a moving deck, to load and unload a tape cassette, is rotatably received therein.

2. Description of the Related Art

In general, magnetic recording/reproducing apparatuses are used to record and reproduce sound or image information with respect to a recording medium such as a magnetic tape. Magnetic recording/reproducing apparatuses include, for example, a video cassette tape recorder (VCR) and a camcorder.

A deck mechanism is employed in the magnetic recording/reproducing apparatus. The magnetic recording/reproducing apparatus further comprises a cassette loading means to move a tape cassette into a predetermined position and a moving deck having a tape running means to take up a magnetic tape from a cassette as the cassette is loaded and running the magnetic tape to a head unit to read the information. Moreover, the apparatus includes a deck chassis assembly for mounting the moving deck and to open and close one end of the moving deck so that the cassette loading means close and opens.

The above-structured deck mechanism is typically driven in accordance with a control program stored in a control part and performs various functions such as loading and unloading of the tape cassette, recording and reproducing of information of the magnetic tape, fast forwarding and rewinding, and the composite driving of the individual components thereof.

FIG. 1 illustrates an example of a conventional deck chassis assembly for a magnetic recording/reproducing apparatus having a moving deck therein.

Referring to FIG. 1, the conventional deck chassis assembly for the magnetic recording/reproducing apparatus comprises a base chassis 10, a housing chassis 20, a left bracket 30, a right bracket 40, a first link 50 and a second link 60.

The base chassis 10 is fixed on a main body (not shown) of the magnetic recording/reproducing apparatus, and the moving deck (not shown) is mounted to an upper part of the base chassis 10.

The housing chassis 20 is rotatable by a predetermined angle about an end thereof such that the cassette loading means of the moving deck mounted in the base chassis 10 may rotate with respect to a front top of the base chassis 10. Thus, the front top section of the base chassis 10 is opened. A door (not shown) is provided on the outside of the housing chassis 20, and has a clamp for preventing the housing chassis 20 from being opened.

The left and right brackets 30 and 40 support the housing chassis 20. Therefore, the housing chassis 20 is disposed above the base chassis 10 and may turn by a predetermined angle with respect to the base chassis 10 using the first and the second links 50 and 60. Upper ends of the left and the right brackets 30 and 40 are rotatably connected to corresponding positions of the housing chassis 20. Lower parts of the left and the right brackets 30 and 40 are respectively fixed to the main body of the magnetic recording/reproducing apparatus.

The first and second links 50 and 60 are interposed between the left bracket 30 and the housing chassis 20. The housing chassis 20 may be opened to a predetermined angle with respect to the base chassis 10. The first and the second links 50 and 60 are rotatably connected by a rivet hinge to each other at one end. The links 50, 60 are also rotatably connected to the housing chassis 20 and the left bracket 30 at the other end of each, respectively, by a rivet hinge.

A locking bracket 70 is provided at the front of the base chassis 10 to engage with the clamp of the door connected to the housing chassis 20. Thus, the housing chassis 20 is prevented from being opened. An example of the locking bracket 70 is illustrated in FIG. 2.

In the above-structured deck chassis assembly for the magnetic recording/reproducing apparatus, when a user pushes the door so that the clamp of the door escapes from the locking bracket 70, the housing chassis 20 turns by a predetermined angle about the rivet hinges. Accordingly, the housing chassis 20 is opened. A sensor (not shown) within the main body senses the housing chassis 20 opened, and therefore, the cassette loading means of the moving deck is ejected. As a result, the user can load or unload a cassette tape to or from the moving deck.

However, the conventional deck chassis assembly for a magnetic recording/reproducing apparatus comprises at least seven parts, including: the base chassis 10, the housing chassis 20, the left and right brackets 30 and 40, the first and second links 50 and 60, and the locking bracket 70. This increases costs for material handling, packaging and management.

In addition, in the conventional deck chassis assembly, the base chassis 10, a sub-assembly of the housing chassis 20, and the locking bracket 70 are separately connected to the main body of the magnetic recording/reproducing apparatus. Therefore, more time is required for assembly, and assembly is difficult.

Furthermore, in the conventional deck chassis assembly, a test for the operation of the moving deck may be performed only after the parts are completely assembled into the deck chassis assembly. Therefore, if a problem arises while processing or assembling the parts, the deck mechanism often needs to be separated from the magnetic recording/reproducing apparatus for reassembly or readjustment. Reassembly or readjustment takes a considerable amount of time.

Accordingly, there is a need for a magnetic recording/reproducing apparatus with improved a deck mechanism which is relatively inexpensive to manufacture and reduces costs for packaging and material handling, by minimizing the number of parts.

### SUMMARY OF THE INVENTION

An aspect of the present invention is to solve at least the above problems and/or disadvantages and to provide at least the advantages described below. Accordingly, an aspect of the present invention is to provide a deck chassis assembly for a magnetic recording/reproducing apparatus, capable of reducing costs for material handling, package and management by minimizing the number of parts.

Another aspect of the present invention is to provide a deck chassis assembly for a magnetic recording/reproducing apparatus, capable of saving assembling time and preventing inferior assembly. This objective is accomplished by mounting the deck chassis assembly to the main body of the magnetic recording/reproducing apparatus as one independent and operable assembly.

Yet another aspect of the present invention is to provide a deck chassis assembly for a magnetic recording/reproducing apparatus capable of reducing time for operational tests and adjustment. Time is reduced by enabling testing of the moving deck prior to completion of deck chassis assembly and moving deck assembly.

In order to achieve the above-described aspects of the present invention, there is provided a base chassis integrally formed with sidewalls at opposite sides thereof to mount and receive the moving deck therein. A housing chassis is provided having sidewalls of which opposite ends thereof are rotatably connected to ends of the sidewalls of the base chassis. A link member is also interposed between the housing chassis and the base chassis to enable the housing chassis to rotate a predetermined angle relative to the base chassis in an opening and closing manner.

The link member comprises a first link rotatably connected to a front of one of the sidewalls of the base chassis at one end, and a second link rotatably connected to a front of one of the sidewalls of the housing chassis at one end and rotatably connected to the other end of the first link at the other end.

The base chassis has a locking part for fixing the door on the front of one of the sidewalls thereof.

A guide groove is formed on one of the sidewalls of the housing chassis, where the link member is not mounted, to guide an opening and closing movement of the housing chassis and a guide pin is formed at a corresponding sidewall of the base chassis to connect to the guide groove.

One of the sidewalls of the base chassis has a sensor mounting portion for receiving a sensor which senses the housing chassis opening and closing, and the corresponding sidewall of the housing chassis has a toggle for operating the sensor.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWING FIGURES

The above and other objects, and features, and advantages of certain embodiments of the present invention will be more apparent from the following description taken in conjunction with the accompanying drawings, in which:

FIG. 1 is a perspective view of an exemplary conventional deck chassis assembly for a magnetic recording/reproducing apparatus;

FIG. 2 is a perspective view of a locking part for fixing a door which is opened and closed by the conventional deck chassis assembly;

FIG. 3 is a perspective view of a deck chassis assembly for a magnetic recording/reproducing apparatus in accordance with an embodiment of the present invention;

FIG. 4 is an exploded perspective view of the deck chassis assembly of the magnetic recording/reproducing apparatus shown in FIG. 3;

FIG. 5 is a perspective view showing a housing chassis of the deck chassis assembly of the magnetic recording/reproducing apparatus of FIG. 3 in a closed position;

FIG. 6 is a perspective view of the deck chassis assembly of the magnetic recording/reproducing apparatus of FIG. 3 mounted with a moving deck and a circuit board;

FIG. 7 is an exploded perspective view showing a dual camcorder, applying the deck chassis assembly according to an embodiment of the present invention, being separated into sub-assemblies;

FIG. 8 is a perspective view of the deck chassis assembly of FIG. 7 on which the door is mounted.

Other objects, advantages, and salient features of the invention will become apparent to those skilled in the art from the following detailed description, which, taken in conjunction with the annexed drawings, discloses preferred embodiments of the invention.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for conciseness.

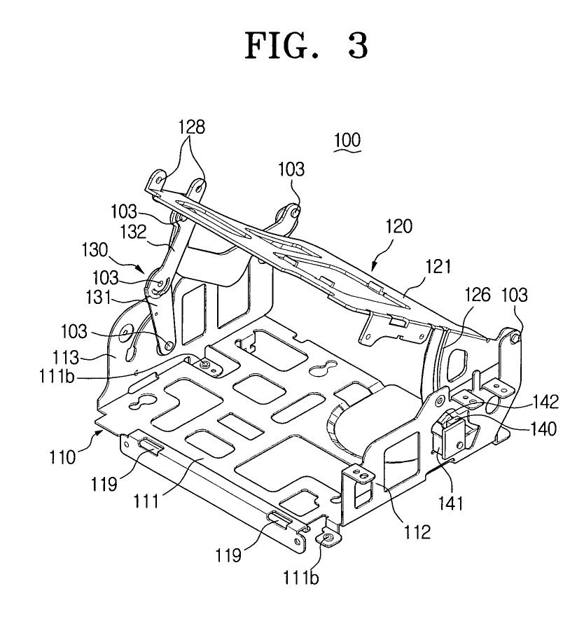

Referring to FIGS. 3 through 5, the deck chassis assembly 100 for a magnetic recording/reproducing apparatus according to an embodiment of the present invention comprises a base chassis 110 mounted in a main body of the magnetic recording/reproducing apparatus, a housing chassis 120 rotatable by a predetermined angle to open and close a top portion of the base chassis 110, and a link member 130 interposed between the base chassis 110 and the housing chassis 120. Thus, the housing chassis 120 may open and close by a predetermined angle with respect to the base chassis 110.

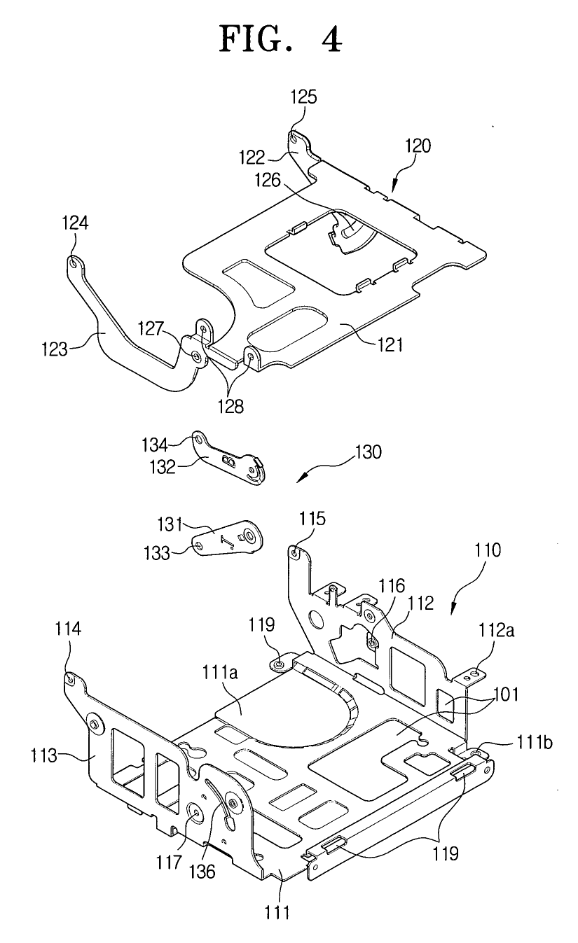

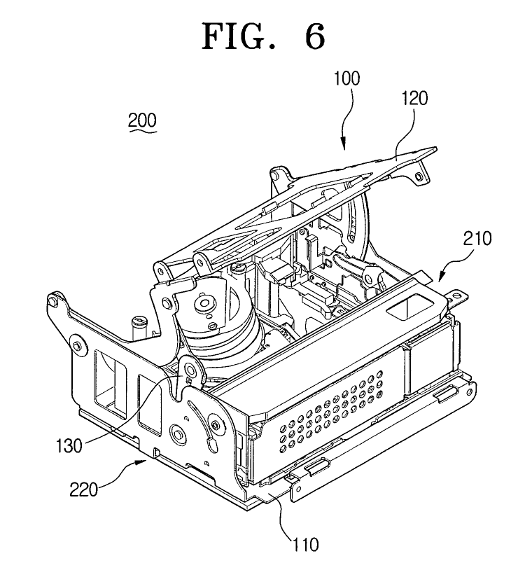

A moving deck 210 (FIG. 6) is mounted at an upper portion of the base chassis 110 to load and unload a tape cassette (not shown). The base chassis 110 has sidewalls 112, 113 integrally formed on opposite sides to define a space for receiving the moving deck 210. Accordingly, the base chassis 110 has a substantially flattened U-shape. As shown in FIG. 4, a motor receiving portion 111a of the moving deck 210, preferably for a capstan motor, is formed by processing a bottom 111 of the base chassis 110. The sidewalls 112,113 of the base chassis 110, respectively, have first hinge holes 114, 115 at upper ends thereof to rotatably connect a rivet hinge 103 with the housing chassis 120 (which will be described hereinbeow in detail). A second hinge hole 117 is formed on one sidewall 113 of the base chassis 110 to rotatably connect with the one end of the link member 130. Thus, the housing chassis 120 may easily turn about the link member 130 by a predetermined angle in an opening and closing manner. Additionally, to control the deck mechanism, the bottom 111 of the base chassis 110 has a plurality of tap holes 111b for fixing the circuit board 220 (FIG. 6). The other sidewall 112 has a plurality of fixing holes 112a to fix the base chassis 110 to the main body of the magnetic recording/reproducing apparatus. In addition to the tap holes 111b and fixing holes 112a, a plurality of openings 101 may be formed on the bottom 111 and sidewalls 112 and 113 of the base chassis 110. This reduces the weight of the base chassis 110. The number of openings 101 is determined in accordance with the strength of the base chassis 110.

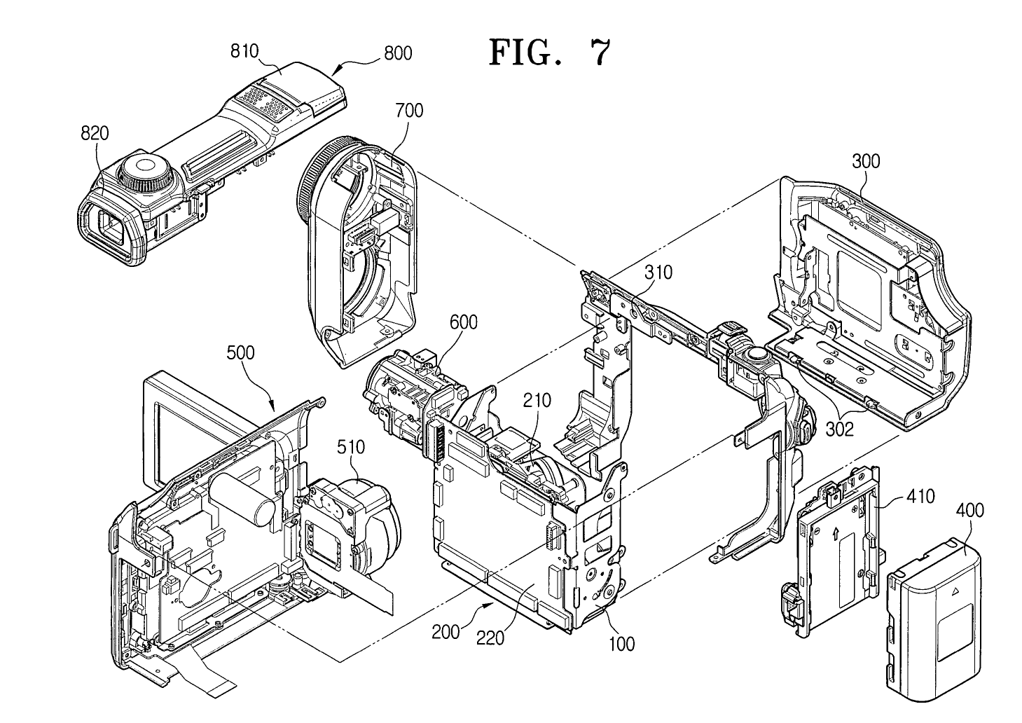

A locking part 119, preferably made by molding, may be provided at the front of the base chassis 110, that is, where the clamp 302 (FIG. 7) of the door 300 (FIG. 7) is inserted when the base chassis 110 is mounted to the main body of the magnetic recording/reproducing apparatus.

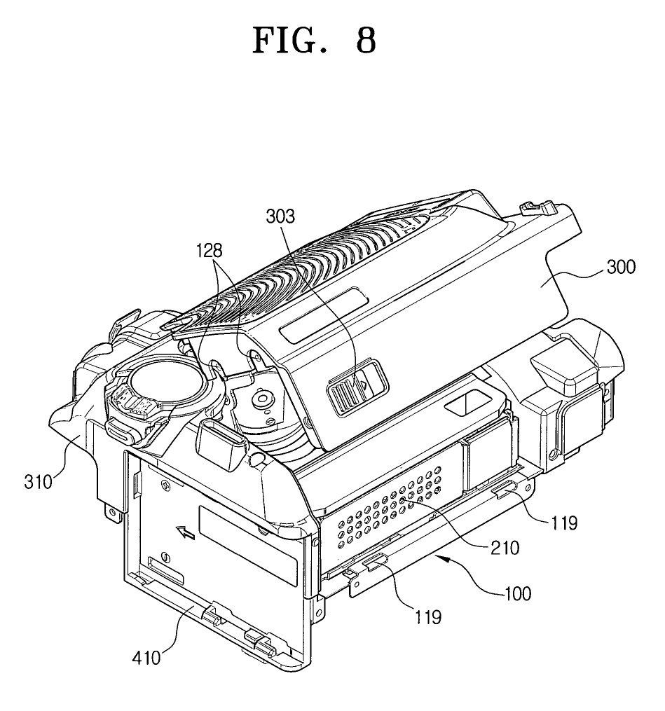

The housing chassis 120 is preferably formed as one body and has a substantially flattened U-shape. The housing chassis 120 has a width receivable in the base chassis 110. Sidewalls 122, 123 of the housing chassis 120, respectively, have third hinge holes 124 and 125 at lower ends thereof for rotatably connected with the base chassis 110 by rivet hinge 103. One sidewall 123 of the housing chassis 120 has a fourth hinge hole 127 formed for rotatable connection with the one end of the link member 130. Thus, the housing chassis 120 can easily turn about the link member 130 by a predetermined angle relative to the base chassis 110. The sidewalls 122, 123 of the housing chassis 120 may have various forms, to the extent that a bottom 121 of the housing chassis 120 maintains suitable strength to open and close the top of the base chassis 110. As shown in FIG. 8, the bottom 121 of the housing chassis 120 includes a door connection hole 128 for connecting the door 300.

A first guide groove 126 is formed on the other sidewall 122 of the housing chassis 120, opposite to the sidewall 123 connected to the link member 130. The first guide groove 126 guides and restricts the opening and closing movement of the housing chassis 120. The sidewall 112 of the base chassis 110, corresponds to the sidewall 122 of the base chassis 120, and is provided with a first guide pin 116 guided by the first guide groove 126. The first guide pin 116 may be formed by processing the rivet hinge 103.

The link member 130 enables the housing chassis 120 to turn relative to the base chassis 110 by a predetermined angle in an opening and closing manner. The link member 130 may be structured in various manners. In this embodiment, the link member 130 comprises a first link 131 and a second link 132.

A first link hole 133 formed on one end of the first link 131. The first link hole 133 is rotatably connected by the rivet hinge 103 with the second hinge hole 117 formed on one sidewall 113 of the base chassis 110. The other end of the first link 131 is rotatably connected with one end of the second link 132 by the rivet hinge 103. A second link hole 134, formed on the other end of the second link 132, is rotatably connected by the rivet hinge 103 with the fourth hinge hole 127 of the sidewall 123 of the housing chassis 120. Accordingly, the first and the second links 131, 132 enable the housing chassis 120 to open and close the top of the base chassis 110 by a predetermined angle. To restrict the turning angle of the first link 131, a second guide groove 136 is formed at one sidewall 113 of the base chassis 110, where the fist link 131 is rotatably connected, and a second guide pin (not shown) is formed corresponding to the second guide groove 136. Consequently, the turning angle of the first link 131 is restricted, thereby smoothing the opening and closing operation of the housing chassis 120.

In order to mount the moving deck 210 and test the operation of the moving deck 210 before the deck chassis assembly 100 is mounted in the main body of the magnetic recording/reproducing apparatus, a sensor 140 is mounted with the deck chassis assembly 100. The sensor 140 detects opening and closing of the housing chassis 120. Thus, a sensor mounting portion 141 is provided on one sidewall 112 of the base chassis 110, and a toggle 142 is provided at the housing chassis 120 to operate the sensor 140. As shown in FIG. 3, the sensor mounting portion 141 is formed outward on one sidewall 112 of the base chassis 110 and has the first guide pin 116. The toggle 142 is formed on the corresponding sidewall 122 of the housing chassis 120 to operate the sensor 140 mounted in the sensor mounting portion 141. Therefore, the sensor 140 is first connected to the circuit board 220 (FIG. 6) to control the moving deck 210 and to a test jig which supplies power to the circuit board 220 (FIG. 6). Thus, the operation of the moving deck 210, which moves in and out according to the opening and closing of the housing chassis 120, can be tested even before complete assemblage of the magnetic recording/reproducing apparatus.

Hereinbelow, an assembling method and the operation of the deck chassis assembly 100 as structured above will be described in greater detail with reference to the accompanying drawings.

The base chassis 110 and the housing chassis 120 are rotatably connected to each other using the rivet hinge 103. The rivet hinge 103 connection is accomplished by aligning the first hinge holes 114, 115 of the base chassis 110 and the third hinge holes 124 and 125 of the housing chassis 120. The rivet hinge 103, preferably of a shaft shape, is inserted in the first and third hinge holes. Both ends of the rivet hinge 103 are compressed by a riveting machine so that the rivet hinges 103 do not come out of the holes. Therefore, the housing chassis 120 and the base chassis 110 can smoothly turn about the rivet hinge 103. When the first guide groove 126 is formed in the housing chassis 120, and the first guide pin 116 is formed in the base chassis 110, the hinge riveting is performed, respectively, to the sidewalls 112 and 113 of the base chassis 110 and the sidewalls 122 and 123 of the housing chassis 120, so that the first guide pin 116 is inserted in the first guide groove 126.

After respective ends of the first and the second links 131, 132 are rotatably connected to each other by the rivet hinge 103, the first link hole 133 of the first link 131 is connected to the second hinge hole 117 of the base chassis 110 by the rivet hinge 103. Additionally, the second link hole 134 is connected to the fourth hinge hole 127 of the housing chassis 120 by the rivet hinge 103. Therefore, the housing chassis 120 can turn relative to the base chassis 110 by a predetermined angle in an opening and closing manner. If the second guide pin (not shown) is formed in the first link 131, and the second guide groove 136 is formed in the sidewall 113 of the base chassis 110, the first link 131 is connected to the base chassis 110 by the rivet hinge 103 after the second guide pin (not shown) is inserted in the second guide groove 136.

Finally, by mounting the sensor 140 in the sensor mounting portion 141 of the base chassis 110, the deck chassis assembly 100 of the magnetic recording/reproducing apparatus is completely assembled.

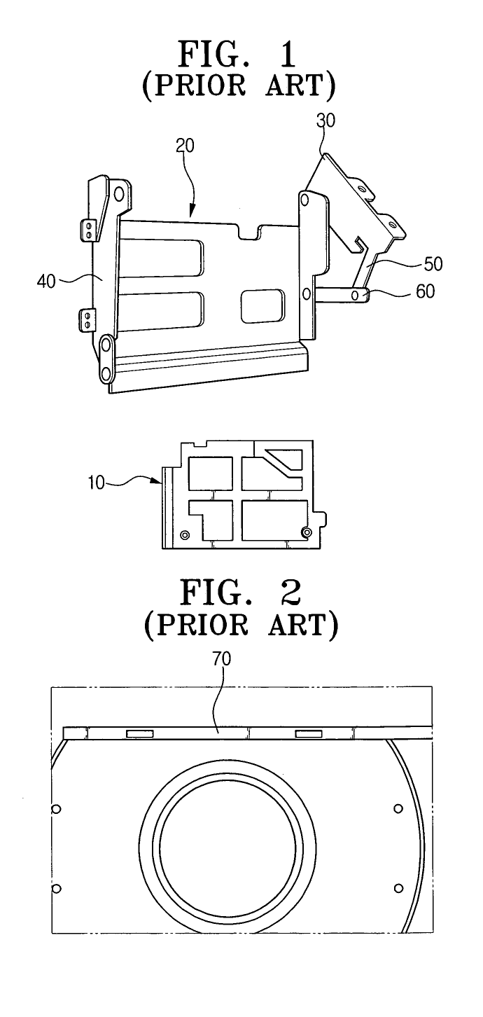

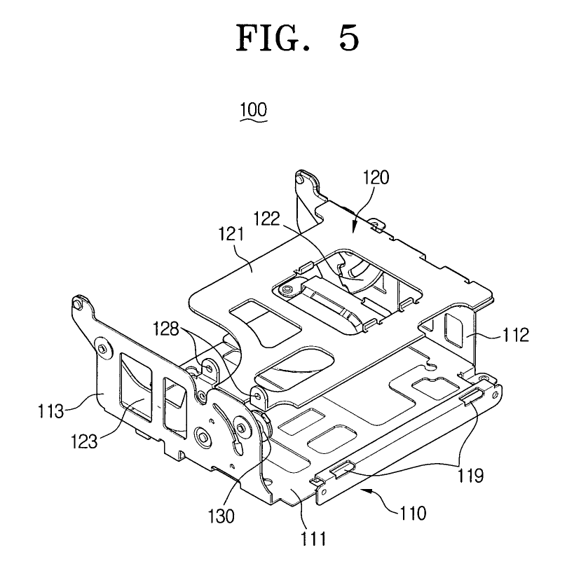

As described above, the base chassis 110, the housing chassis 120, the first link 131 and the second link 132 are rotatably connected by the rivet hinge 103 at five spots. Therefore, a user can open and close the housing chassis 120 relative to the base chassis 110 by a predetermined angle simply by pushing a front of the housing chassis 120. More specifically, as shown in FIG. 1, when the user pushes upwardly on the front of the housing chassis 120, the housing chassis 120 is opened by a predetermined angle. As shown in FIG. 5, when the user pushes downwardly on the front of the housing chassis 120, the housing chassis 120 closes the top of the base chassis 110.

As shown in FIG. 6, the moving deck 210 and the circuit board 220 controlling the moving deck 220 are mounted to the above-assembled deck chassis assembly 100, thereby completing a deck assembly 200.

Hereinbelow, with reference to FIGS. 7 and 8, a dual camcorder having a camera lens and a camcorder lens will be described as an example of the magnetic recording/reproducing apparatus which applies the deck chassis assembly according to an embodiment of the present invention.

Referring to FIG. 7, the dual camcorder comprises the deck assembly 200 including the moving deck 210 in which the tape cassette (not shown) is loaded and unloaded. Additionally, door 300 is connected to the housing chassis 120 and left casing 310 serves as a frame of the door A battery mounting portion 410 is formed at a rear side of the left casing 310 to mount a battery 400 therein. A right casing 500 constitutes a main body of the dual camcorder together with the left casing 310 and comprises a subassembly with a camera unit which includes a camera lens 510. A camcorder lens unit 600 is fixed at front side of the deck assembly 200. The dual camcorder also includes a front casing 700 for fixing the camera lens 510 and the camcorder lens unit 600, and an upper casing 800 including a flash 810 and a viewfinder 820.

The deck assembly 200 comprises the deck chassis assembly 100 according to an embodiment of the present invention. The moving deck 210 is mounted to the deck chassis assembly 100, and the circuit board 220. The circuit board 220 comprises a moving image processing circuit for photographing a moving image as well as a circuit for controlling the moving deck 210. The left casing 310 is fixed to the deck assembly 200, and the door 300 is mounted to the door connection hole 128 of the housing chassis 120, as shown in FIG. 8. If the door 300 is pressed, in this state, the clamp 302 (FIG. 7) formed at an inside of a lower portion of the door 300 is engaged with the locking part 119 of the deck chassis assembly 100. , As shown in FIG. 8, in order to open the door 300, a clamp releasing button 303, provided at an outside of the lower part of the door 300, is pushed in a sliding manner so that the clamp 302 escapes from the locking part 119. When the door 300 is open, the toggle 142 of the housing chassis 120 is disposed on a front of the sensor 140. Therefore, the sensor 140 senses the door 300 opened and transmits a signal to the circuit board 220. Accordingly, the circuit board 220 controls the moving deck 210 so that the cassette loading means of the moving deck 210 protrudes with respect to the base chassis 110. When the cassette loading means of the moving deck 210 protrudes, the user can load or unload the tape cassette to or from the moving deck 210. The operation of the moving deck 210, including loading the tape cassette toward a head drum and controlling running of a magnetic tape, will not be described in detail since it is the same as in conventional moving decks.

The deck assembly 200, the left casing 310 and the door 300 are sub-assembled by mounting the right casing 500, the camcorder lens unit 600, the front casing 700 and the upper casing 800 in order, and assembly of the dual camcorder is complete.

As can be appreciated from the above description, the deck chassis assembly for a magnetic recording/reproducing apparatus according to an embodiment of the present invention may save costs for material handling, packaging and management by reducing the number of component parts. While the conventional deck chassis assembly comprises seven parts, the deck chassis assembly 200 according to an embodiment of the present invention comprises only the following four main parts: the base chassis, the housing chassis, the first link and the second link.

In the deck chassis assembly for a magnetic recording/reproducing apparatus according to an embodiment of the present invention, the deck chassis assembly 200 is mounted to the main body of the magnetic recording/reproducing apparatus, as one independent module. Therefore, assembly time is minimized. Moreover, assembly thereof is simplified.

Moreover, according to an embodiment of the present invention, an operation test for the moving deck 210 may be performed using a test jig when the deck chassis assembly 200 and the moving deck 210 are sub-assembled. In other words, since the quality of the deck chassis assembly 200 may be tested and adjusted before complete assemble of the magnetic recording/reproducing apparatus, time testing and adjustments is saved.

While the invention has been shown and described with reference to certain embodiments thereof, it will be understood by those skilled in the art that various changes in form and details may be made therein without departing from the spirit and scope of the invention as defined by the appended claims.

1. A deck chassis assembly for a magnetic recording/reproducing apparatus, including a moving deck to open and close a door so that the moving deck submerges and emerges, the deck chassis assembly comprising:
a base chassis mounting integrally formed with sidewalls at opposite sides thereof to mount and receive the moving deck therein;
a housing chassis having sidewalls of which opposite ends thereof are rotatably connected to ends of the sidewalls of the base chassis; and
a link member interposed between the housing chassis and the base chassis to enable the housing chassis to rotate a predetermined angle relative to the base chassis in an opening and closing manner.

2. The deck chassis assembly of claim 1, wherein
the link member comprises a first link rotatably connected to a front of one of the sidewalls of the base chassis at one end; and
a second link rotatably connected to a front of one of the sidewalls of the housing chassis at one end and rotatably connected to the other end of the first link at the other end.

3. The deck chassis assembly of claim 2, wherein
the base chassis has a locking part for fixing the door on the front of one of the sidewalls thereof.

4. The deck chassis assembly of claim 2, wherein
a guide groove is formed on one of the sidewalls of the housing chassis, where the link member is not mounted, to guide an opening and closing movement of the housing chassis, and a guide pin is formed at a corresponding sidewall of the base chassis to connect to the guide groove.

5. The deck chassis assembly of claim 4, wherein
one of the sidewalls of the base chassis has a sensor mounting portion for receiving a sensor which senses the housing chassis opening and closing, and the corresponding sidewall of the housing chassis has a toggle for operating the sensor.

6. A deck chassis assembly for a magnetic recording/reproducing apparatus, including a moving deck to open and close a door so that the moving deck closes and opens, the deck chassis assembly comprising:
a base chassis mounting integrally formed with sidewalls at opposite sides thereof to mount and receive the moving deck therein;
a housing chassis having sidewalls of which opposite ends thereof are rotatably connected to ends of the sidewalls of the base chassis;
a link member interposed between the housing chassis and the base chassis to enable the housing chassis to rotate a predetermined angle relative to the base chassis in an opening and closing manner; and
the link member comprises a first link rotatably connected to a front of one of the sidewalls of the base chassis at one end.

7. The deck chassis assembly of claim 6, wherein
a second link rotatably connected to a front of one of the sidewalls of the housing chassis at one end and rotatably connected to the other end of the first link at the other end.

8. The deck chassis assembly of claim 6, wherein
the base chassis has a locking part for fixing the door on the front of one of the sidewalls thereof.

9. The deck chassis assembly of claim 6, wherein
a guide groove is formed on one of the sidewalls of the housing chassis, where the link member is not mounted, to guide an opening and closing movement of the housing chassis, and a guide pin is formed at a corresponding sidewall of the base chassis to connect to the guide groove.

10. The deck chassis assembly of claim 6, wherein
one of the sidewalls of the base chassis has a sensor mounting portion for receiving a sensor which senses the housing chassis opening and closing, and the corresponding sidewall of the housing chassis has a toggle for operating the sensor.
